(19) United States
(12) Patent Application Publication
(10) Pub. No.: US 2014/0068242 A1
(43) Pub. Date: Mar. 6, 2014

(54) IMAGE FORMING APPARATUS, METHOD FOR CONTROLLING IMAGE FORMING APPARATUS, AND STORAGE MEDIUM

(71) Applicant: CANON KABUSHIKI KAISHA, Tokyo (JP)

(72) Inventor: Yoshiharu Ito, Kawasaki-shi (JP)

(73) Assignee: CANON KABUSHIKI KAISHA, Tokyo (JP)

(21) Appl. No.: 14/010,694

(22) Filed: Aug. 27, 2013

(30) Foreign Application Priority Data
Aug. 28, 2012 (JP) 2012-187392

(51) Int. Cl. G06F 9/44

(52) U.S. Cl. CPC G06F 9/4418
USPC 713/2

(57) ABSTRACT

An image forming apparatus, which is configured to perform image processing while managing a resource of a system, includes a memory, a detection unit configured to detect a brightness level around a main body of the image forming apparatus, and a control unit configured to reboot the resource of the system, check a state in which the system should be rebooted to determine which level this state has shifted to, reserve reboot processing according to the determined level, and control whether the reboot processing should be performed by the reboot unit according to the detected brightness level and a level of the reserved reboot processing.

### BACKGROUND

1. Field

Aspects of the present invention generally relate to an image forming apparatus, a method for controlling an image forming apparatus, and a storage medium.

2. Description of the Related Art

Image forming apparatuses, which are represented by multifunction peripherals, may be kept operating continuously for a long time in some usage, and this usage has become common in recent years because they include a facsimile function and a network communication function.

For example, Japanese Patent Application Laid-Open No. 2005-229210 discusses an image forming apparatus that operates continuously for a long time. This image forming apparatus is rebooted immediately upon detection of a failure that is highly likely recovered by reboot to improve the reliability of the apparatus.

Further, such image forming apparatuses are subject to not only a failure but also a phenomenon called fragmentation. The fragmentation progresses according to accumulation of the number of times of memory access within the image forming apparatus. With the further progress of the fragmentation, when some job or the like is supposed to secure a continuous memory area having a significant size to some extent, it may be impossible or take a long time to secure such a memory area.

On the other hand, due to a potential factor of software, the number of available memory areas may reduce gradually, resulting in an eventual inability to secure a memory area.

There is such a problem that these phenomena prevent the software from operating stably, leading to an unstable operation thereof.

One method for solving the above-described problem is to periodically power off or reboot the image forming apparatus to prevent the number of times of access from accumulating, thereby periodically cleaning the use status of the memory.

For example, Japanese Patent Application Laid-Open No. 2006-229509 discusses a technique in which, at the time of rebooting an apparatus during a continuous operation thereof, it is determined that a user is not using the apparatus based on such a condition that the apparatus has not been used for a predetermined time from a shift to a power saving mode, and then the apparatus is rebooted.

Some of the image forming apparatuses that operate continuously have a function of shifting to a power saving state in view of power saving. However, even in this state, the fact remains that the image forming apparatus operates continuously from the point of view of software inside the image forming apparatus, and this function cannot solve the present problem.

However, it cannot be said that the above-described method is enough to completely detect whether and how the user uses the apparatus.

In recent years, generally, the image forming apparatuses have been used with a waiting time until a shift to the power saving state set short so as to facilitate this shift in view of power saving. Therefore, it is relatively highly possible that the image forming apparatus starts reboot processing despite user's intention when the user is about to use the image forming apparatus.

Further, with the advancement of sophistication and multifunctionality of the recent image forming apparatuses, rebooting the apparatus (including the resource of the system) often requires a long time. This is also another factor for a reduction in the usability of users.

### SUMMARY

The present disclosure is directed to providing a mechanism allowing further correct detection of such a status that a user is not using a main body of an image forming apparatus, and execution of required reboot processing at an appropriate timing.

According to an aspect of the present invention, an image forming apparatus configured to perform image processing while managing a resource of a system includes a detection unit configured to detect a brightness level around a main body of the image forming apparatus, and a control unit configured to reboot the resource of the system, check a state in which the system should be rebooted to determine which level this state has shifted to, reserve reboot processing according to the determined level, and control whether the reboot processing should be performed by the reboot unit according to the detected brightness level and a level of the reserved reboot processing.

Further features and aspects of the present disclosure will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration of an image forming apparatus according to an exemplary embodiment.

FIG. 2 illustrates a table that manages available memory management information indicating an available state of a random access memory (RAM).

FIG. 3 illustrates a table that manages the available memory management information indicating the available state of the RAM.

FIG. 4 illustrates the details of an available block illustrated in FIG. 2.

FIG. 5 is a flowchart illustrating a method for controlling the image forming apparatus.

FIG. 6 is a flowchart illustrating a method for controlling the image forming apparatus.

FIG. 7 is a flowchart illustrating a method for controlling the image forming apparatus.

FIG. 8 illustrates the relationship between abnormality levels and reboot, which is managed by the image forming apparatus.

FIG. 9 is a flowchart illustrating a method for controlling the image forming apparatus.

FIG. 10 is a flowchart illustrating a method for controlling the image forming apparatus.

FIG. 11 is a flowchart illustrating a method for controlling the image forming apparatus.

FIG. 12 is a flowchart illustrating a method for controlling the image forming apparatus.

### DESCRIPTION OF THE EMBODIMENTS

Various exemplary embodiments, features, etc., will be described in detail below with reference to the drawings. Exemplary embodiments that will be described below are not seen to be limiting, and all of combinations of features described in the exemplary embodiments are not necessarily essential.

### <Description of System Configuration>

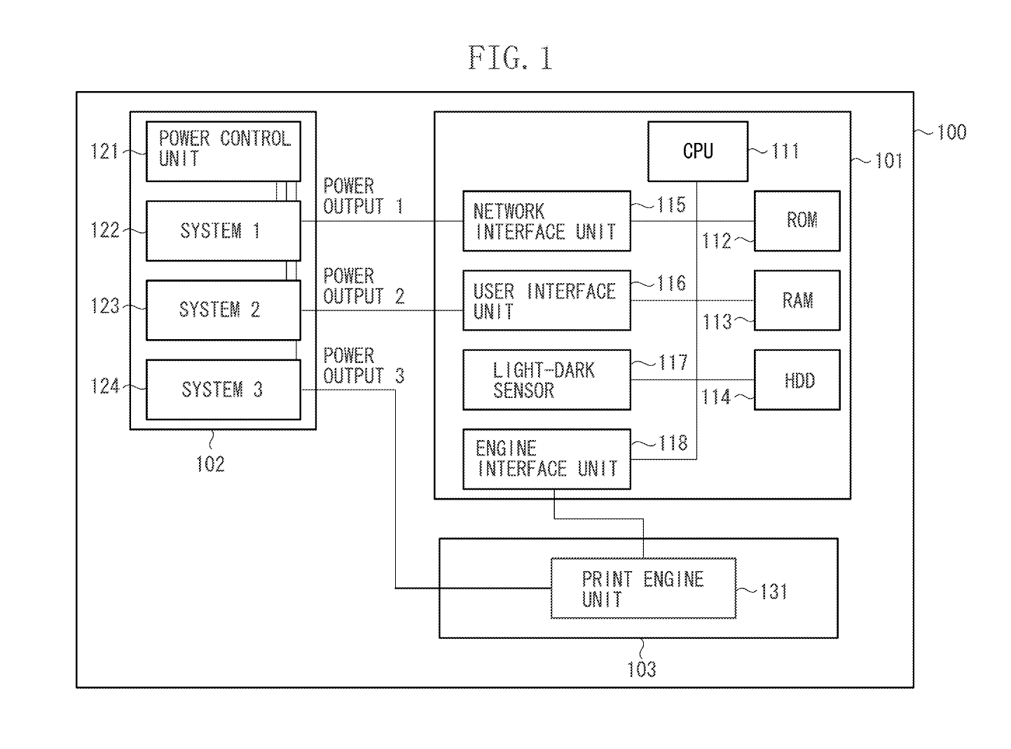

FIG. 1 is a block diagram illustrating a configuration of an image forming apparatus according to a first exemplary embodiment. The present exemplary embodiment will be described based on an image forming apparatus that has only a printer function. However, the image forming apparatus according to the present embodiment is not limited thereto, and can be employed to, for example, a multifunctional image forming apparatus (a multifunction peripheral) that has a scanner function, a facsimile function, a storage function, and the like. The present exemplary embodiment will be described based on an example that uses a hard disk drive (HDD) as a non-volatile storage device, but may use another non-volatile storage device. The image forming apparatus according to the present exemplary embodiment performs image processing while managing a resource of a system, as will be described below.

Referring to FIG. 1, a main control unit 101 of the image forming apparatus includes a central processing unit (CPU) 111 for executing software, and includes a read only memory (ROM) 112 and an HDD 114 as non-volatile storage devices. Further, the main control unit 101 includes a RAM 113 as a volatile storage device, and uses the RAM 113 as an area where the main control unit 101 develops a program stored in the HDD 114 into an executable form, and a work area where data is stored. The CPU 111 manages the volatile memory (the use status of the RAM 113) as an example of the resource of the system.

A network interface unit 115 is connected to a not-illustrated host computer, and for example, receives print data and an inquiry packet, and transmits a response packet. A user interface unit 116 includes a liquid crystal display that displays an apparatus state and an input key to be operated manually by a user.

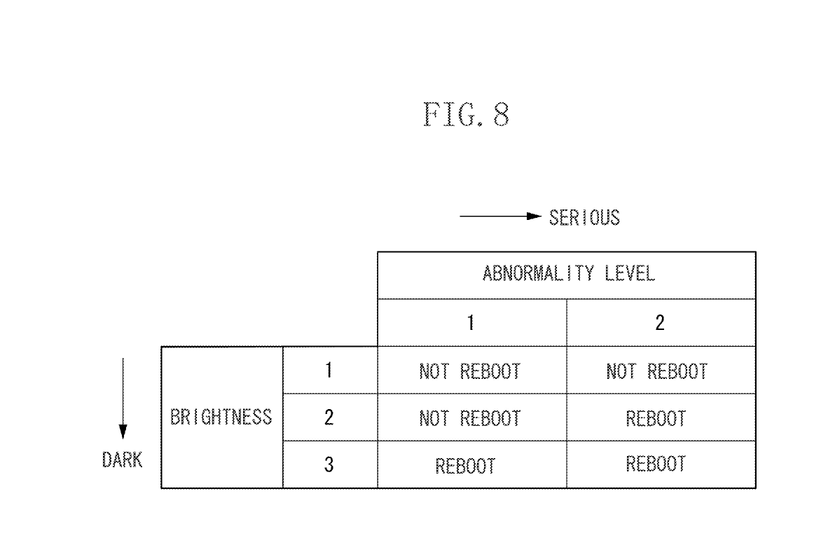

An engine interface unit 118 communicates with a print engine unit 103 (131), which will be described below. The print engine unit 103 is a printing unit that prints data on paper, which is realized by, for example, an electrophotographic method or an inkjet method. A power supply unit 102 includes a plurality of power supply systems 122 to 124, and a power control unit 121 for controlling the power supply systems 122 to 124. A lightness sensor 117 can detect brightness (a brightness level) around the image forming apparatus. The lightness sensor 117 detects at least three stages of brightness levels (refer to FIG. 8, which will be described below).

The image forming apparatus according to the present exemplary embodiment detects a shift to such a state that the image forming apparatus should be rebooted, and this processing will be described next. Examples of phenomena associated with abnormality include fragmentation of the RAM 113, which occurs in the RAM 113, and the following description will be provided based on this example. However, the phenomenon associated with abnormality may be another example as long as it is a detectable state, and is not limited to fragmentation of the RAM 113.

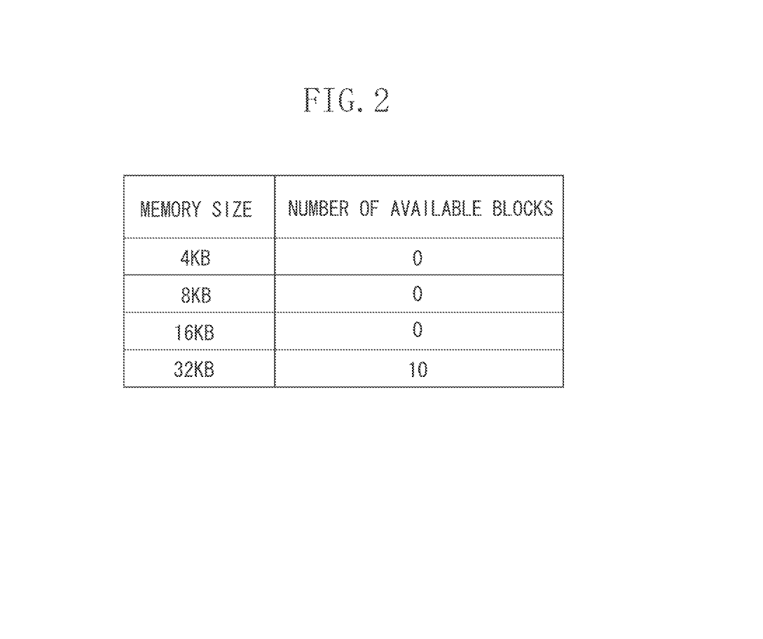

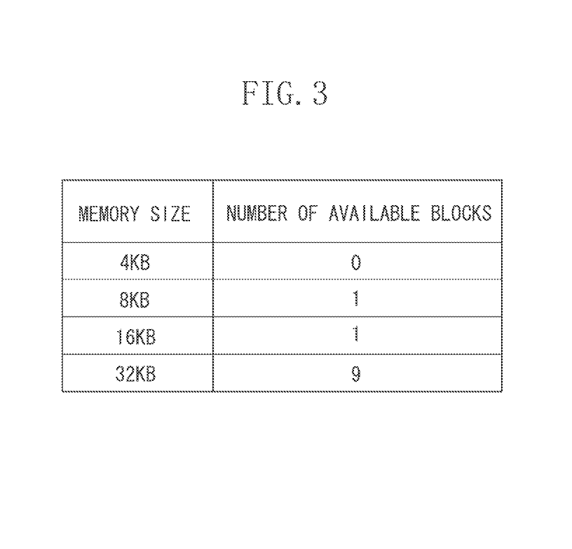

FIGS. 2 and 3 illustrate an example of a table that manages available memory management information, which indicates an available state of the RAM 113 illustrated in FIG. 1. In the present example, an available memory is divided into blocks each having a significant memory size to some extent, and is managed by blocks. This example indicates that ten memory areas each having a size of 32 KB are available with memory areas of other sizes unavailable. In the present exemplary embodiment, the memory is managed in such a manner that memory blocks having a plurality of capacities are assigned to a single block.

When software requests an available memory having a size of 8 KB in this state, this request is processed by permitting memory use to the request source with use of an available block having a size of 32 KB, which is a larger size, because there is no available block having a size just fit to the request.

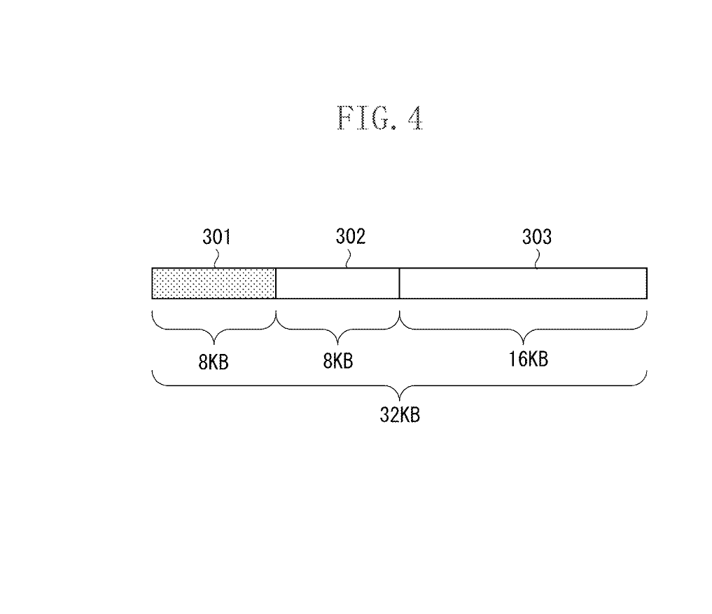

FIG. 4 illustrates the details of the available block illustrated in FIG. 2. In the present example, an available continuous block originally having a size of 32 KB is divided into two 8 KB blocks 301 and 302, and a single 16 KB block 303, which are smaller management units. Then, the request source is permitted to use the 8 KB block 301, which is one of the divided blocks.

The remaining blocks, i.e., the single 8 KB block 302 and the single 16 KB block 303 continue being managed as available areas.

As a result, the available memory management information when processing the memory request has been completed indicates the memory available state illustrated in FIG. 3. The number of available continuous 32 KB blocks reduces by one, and the number of 8 KB block and the number of 16 KB block each increase by one. Although the requested necessary memory area is an 8 KB area, the result is a reduction in the number of available continuous memory blocks of 32 KB, which is a larger size than the request.

The above-described example indicates that, if a memory request is processed in this manner, an available memory block having a large size is fragmented into available memory blocks having smaller sizes, and is used as the memory blocks having the smaller sizes, depending on the block available state at that time. As this processing is repeated, available large size memories are lost one by one, resulting in a gradual reduction in the number of available continuous memory areas having the large size.

If a memory request is limited to a request for a small size area, the image forming apparatus can continue operating for the time being. However, once a request is issued for an available continuous memory having a large size, this triggers an unstable operation of the image forming apparatus in such a manner that the image forming apparatus cannot continue operating anymore and has to stop its operation or has to be rebooted.

Therefore, monitoring the progress status of the fragmentation can contribute to a determination about whether the operation of the image forming apparatus could become unstable.

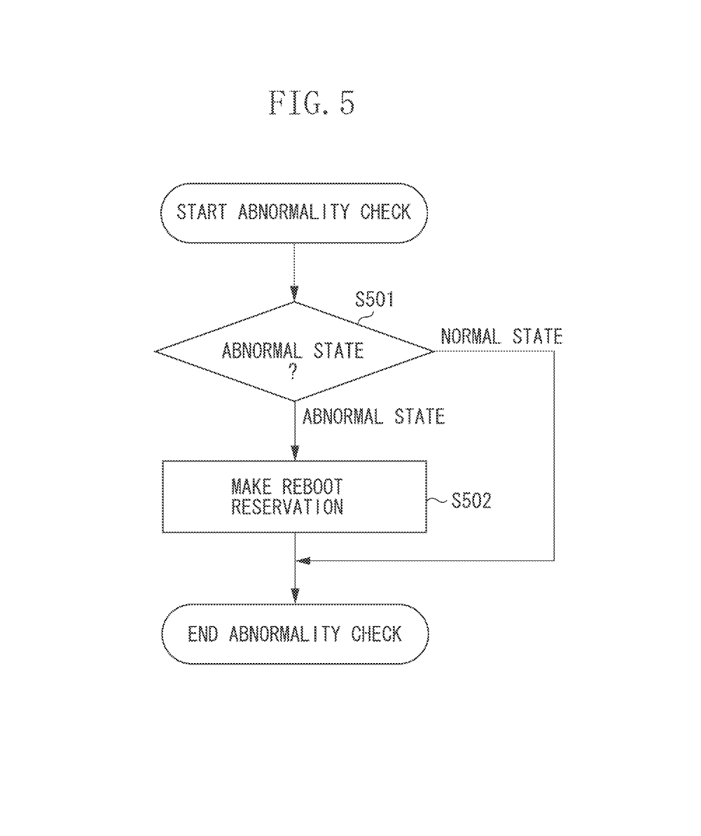

FIG. 5 is a flowchart illustrating a method for controlling the image forming apparatus according to the present exemplary embodiment. The present example is an example of processing for detecting a state associated with abnormality in the image forming apparatus, and the present processing is assumed to be periodically performed when the image forming apparatus is in operation. The CPU 111 executes a control program stored in the ROM 112 or HDD 114, by which the respective steps are realized. In the following description, processing for checking a state in which the system should be rebooted to determine which level this state has shifted to, and reserving reboot processing according to the determined level will be described.

In step S501, the CPU 111 performs processing for checking a predetermined abnormal state. The content of the processing for checking the abnormal state will be described in detail below. If the CPU 111 determines that the image forming apparatus is in a normal state by the check processing (NORMAL STATE in step S501), the CPU 111 ends the present processing with nothing performed. On the other hand, if the CPU 111 determines that the image forming apparatus is in the predetermined abnormal state (ABNORMAL STATE in step S501), in step S502, the CPU 111 makes a reboot reservation by storing abnormality information in a not-illustrated holding unit, and then ends the present processing. As a result, the reboot processing does not start immediately even if the abnormal state is detected.

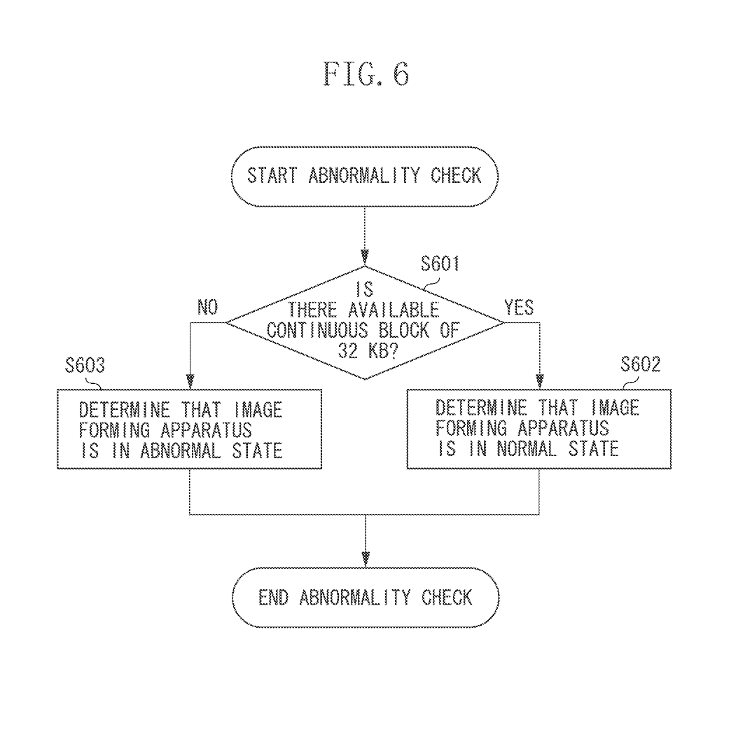

FIG. 6 is a flowchart illustrating a method for controlling the image forming apparatus according to the present exemplary embodiment. This example is an example of the details of the processing for checking the abnormal state in step S501 in FIG. 5, and the processing is assumed to be periodically performed when the image forming apparatus is in operation. In the present exemplary embodiment, the processing is an example of processing for checking the progress status of fragmentation of the RAM 113. This processing content is an example of the check processing, and the check processing does not necessarily have to be performed in this manner. The CPU 111 executes the control program stored in the ROM 112 or HDD 114, by which the respective steps are realized.

In step S601, the CPU 111 refers to the available memory management information described with reference to FIGS. 2 and 3, and checks whether there is an available continuous block of 32 KB. If the CPU 111 determines in step S601 that there is an available continuous block of 32 KB (YES in step S601), in step S602, the CPU 111 determines that the image forming apparatus is in a normal state, and then ends the present processing.

On the other hand, if the CPU 111 determines in step S601 that there is no available continuous block of 32 KB (NO in step S601), in step S603, the CPU 111 determines that the image forming apparatus is in an abnormal state, and then ends the present processing.

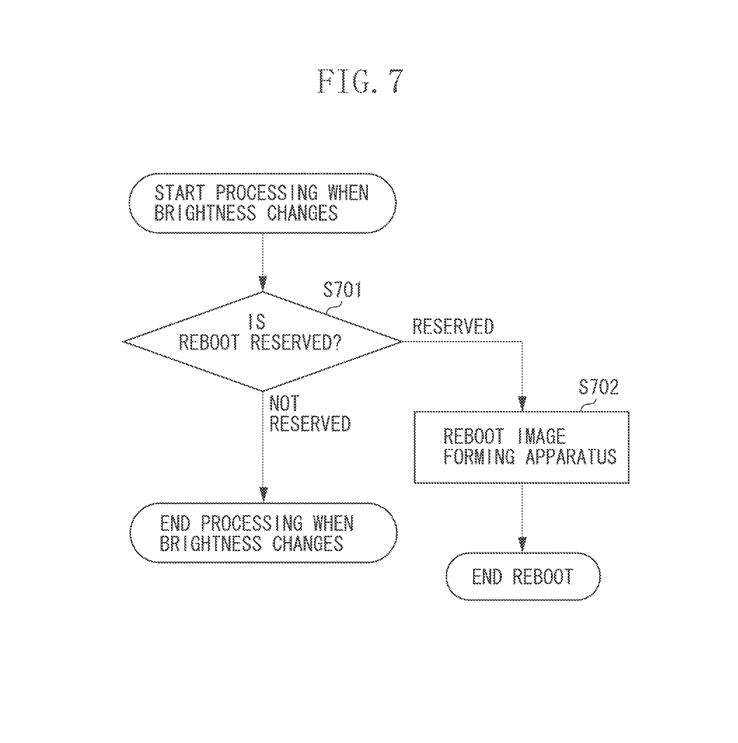

FIG. 7 is a flowchart illustrating a method for controlling the image forming apparatus according to the present exemplary embodiment. The present example is an example of processing performed when the lightness sensor 117 provided to the image forming apparatus 100 detects that the brightness has changed to a dark side beyond a threshold value. The CPU 111 executes the control program stored in the ROM 112 or HDD 114, by which the respective steps are realized.

In step S701, the CPU 111 refers to the abnormal state held by the not-illustrated holding unit, and determines whether reboot is reserved. If the CPU 111 determines in step S701 that reboot is not reserved (NOT RESERVED in step S701), the CPU 111 ends the present processing.

On the other hand, if the CPU 111 determines in step S701 that reboot is reserved (RESERVED in step S701), in step S702, the CPU 111 performs conventional commonly-used reboot processing, and then ends the present processing.

According to the above-described processing, it is possible to detect in advance that the image forming apparatus could shift to an abnormal state to thereby reserve the reboot processing, and wait until it gets dark around the image forming apparatus to reboot the image forming apparatus at an appropriate timing that does not interrupt a job processing request of the image forming apparatus.

The above-described first exemplary embodiment has been described based on the example in which there is only a single content associated with abnormality to be detected. A second exemplary embodiment will be described based on an example in which there is a plurality of contents to be detected, and the lightness sensor 117 detects a plurality of levels of brightness. A different feature of the second exemplary embodiment from the first exemplary embodiment lies in an increase in the number of contents of types of factors that cause reboot and the number of conditions for a determination about whether reboot should be reserved according to the levels of brightness.

FIG. 8 illustrates the relationship between abnormality levels and reboot, which is managed by the image forming apparatus according to the present exemplary embodiment. This example is managed by the CPU 111 as a table systematically storing information indicating whether reboot should be reserved according to the types of abnormality levels and the levels of brightness. In the present exemplary embodiment, if a predetermined available capacity (32 KB) cannot be secured in the volatile memory (the RAM 113), it is determined that the level of the reboot processing is a high level (a level 2). Similarly, if a predetermined available continuous capacity (32 KB) cannot be secured in the volatile memory, it is determined that the level of the reboot processing is a middle level (a level 1).

Referring to FIG. 8, there are two types of abnormality levels and three stages of brightness levels in the present exemplary embodiment. For the abnormality level, the level 1 and the level 2 mean minor abnormality and serious abnormality, respectively. For the brightness level, the level 1 and the level 3 mean the lightest state and the darkest state, respectively.

As illustrated in FIG. 8, the operation varies depending on the type of the abnormality level when the brightness is at the level “2”. If the abnormality level 1 is detected at this time, reboot is not reserved. If the abnormality level 2 is detected at this time, reboot is reserved. Therefore, this table indicates that the image forming apparatus is rebooted in the abnormality level 2 even if it is lighter compared to the abnormality level 1, and this abnormality level is considered to be a more serious resource state.

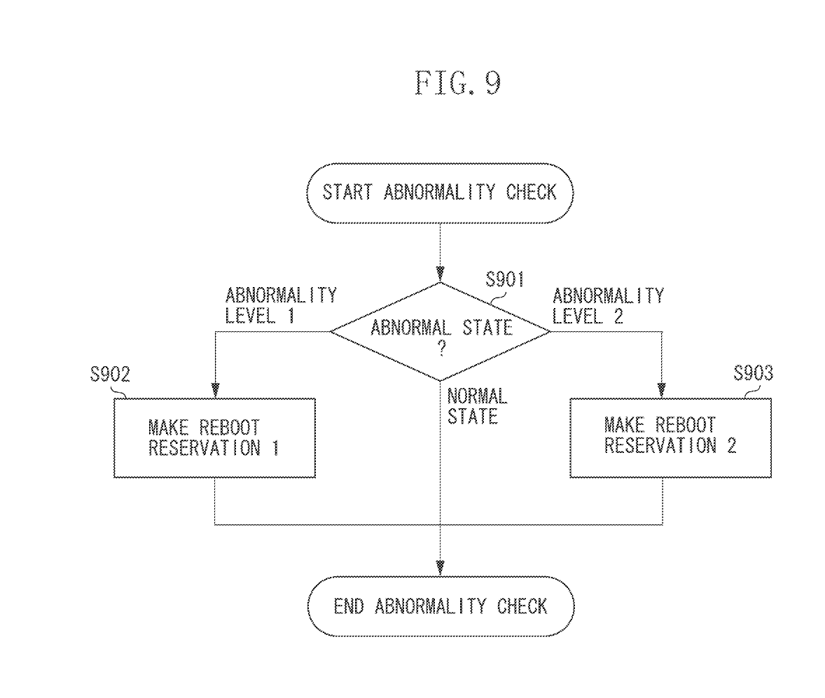

FIG. 9 is a flowchart illustrating a method for controlling the image forming apparatus according to the present exemplary embodiment. The present example is an example of processing for detecting the resource state of the image forming apparatus, and the processing is assumed to be periodically performed when the image forming apparatus is in operation. The CPU 111 executes the control program stored in the ROM 112 or HDD 114, by which the respective steps are realized.

In step S901, the CPU 111 performs processing for checking existence or absence of abnormality, and the level of the abnormality. The processing content will be described in detail below. If the CPU 111 determines in step S901 that the image forming apparatus is in a normal state by the check processing (NORMAL STATE in step S901), the CPU 111 ends the present processing.

On the other hand, if the CPU 111 determines in step S901 that the image forming apparatus is in an abnormal state, the processing varies according to the abnormality level thereof. More specifically, if the CPU 111 detects the abnormal state and determines that the abnormality level 1 is detected in step S901 (ABNORMALITY LEVEL 1 in step S901), in step S902, the CPU 111 makes a reboot reservation 1 by storing the abnormality level 1 in the not-illustrated holding unit.

If the CPU 111 detects the abnormal state and determines that the abnormality level 2 is detected in step S901 (ABNORMALITY LEVEL 2 in step S901), in step S903, the CPU 111 makes a reboot reservation 2 by storing the abnormality level 2 in the not-illustrated holding unit, and then ends the present processing.

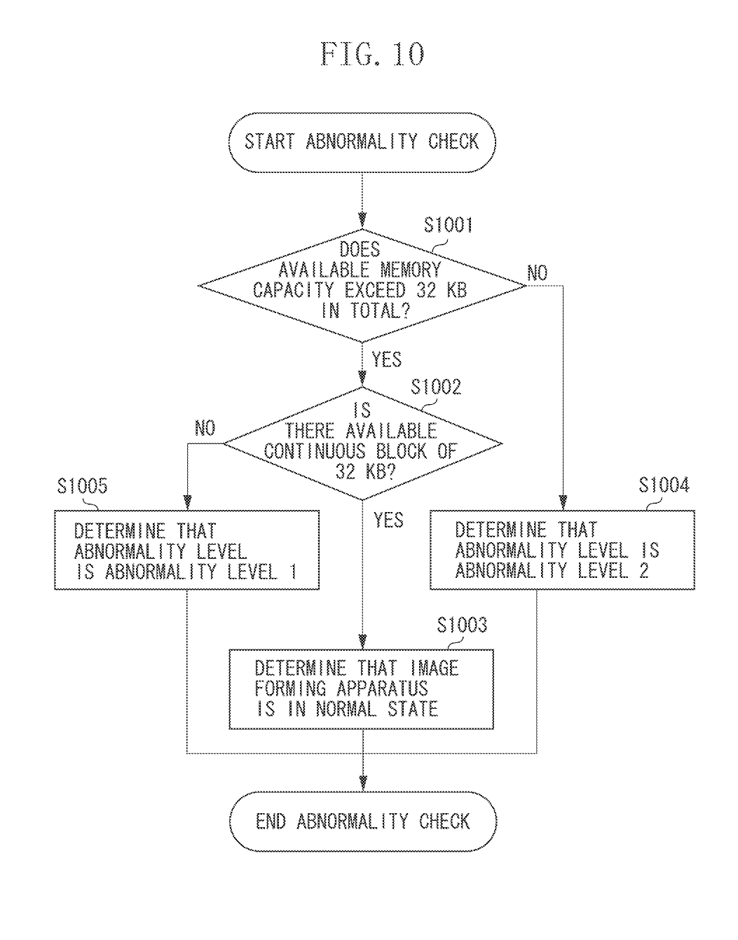

FIG. 10 is a flowchart illustrating a method for controlling the image forming apparatus according to the present exemplary embodiment. The present example is an example of the details of the processing for checking the abnormal state in step S901 in FIG. 9, and the present processing is processing for checking two items, i.e., the absolute available memory capacity of the RAM 113 and the progress status of fragmentation of the RAM 113. Further, the present processing content is an example of the check processing, and the check processing does not necessarily have to be performed in this manner. The CPU 111 executes the control program stored in the ROM 112 or HDD 114, by which the respective steps are realized.

In step S1001, the CPU 111 refers to the available memory management information described with reference to FIGS. 2 and 3, and calculates the absolute available memory capacity from the sizes and the number of the currently available blocks. The CPU 111 determines whether the total of this available memory capacity exceeds 32 KB. If the CPU 111 determines in step S1001 that the total of the available memory capacity exceeds 32 KB (YES in step S1001), the CPU 111 determines that the available memory capacity is in a normal state.

Then, in step S1002, the CPU 111 performs processing for checking whether the memory fragmentation phenomenon has progressed in a similar manner to step S601 illustrated in FIG. 6. More specifically, the CPU 111 refers to the available memory management information described with reference to FIGS. 2 and 3, and determines whether there is an available continuous block of 32 KB. If the CPU 111 determines in step S1002 that there is an available continuous block of 32 KB (YES in step S1002), in step S1003, the CPU 111 determines that the image forming apparatus is in a normal state, and then ends the present processing.

On the other hand, if the CPU 111 determines in step S1001 that the total of the available memory capacity is 32 KB or less (NO in step S1001), in step S1004, the CPU 111 determines that the abnormality level is the abnormality level 2, and then ends the present processing. This is because there is a high possibility of occurrence of a phenomenon generally called memory leak, which is such a phenomenon that some influence is exerted on the processing in which the software temporarily holds a memory and then releases the memory, and the software continues holding the memory without releasing it. This phenomenon is more serious memory use state compared to the fragmentation described above as an example of the memory use state, and it is less likely that the image forming apparatus can continue operating. Therefore, the present exemplary embodiment makes such an arrangement that the image forming apparatus can be rebooted even if it is lighter around the image forming apparatus.

On the other hand, if the CPU 111 determines in step S1002 that there is no available continuous block of 32 KB (NO in step S1002), it is considered that the above-described fragmentation phenomenon has progressed. Therefore, in step S1005, the CPU 111 determines that the abnormality level is the abnormality level 1, and then ends the present processing.

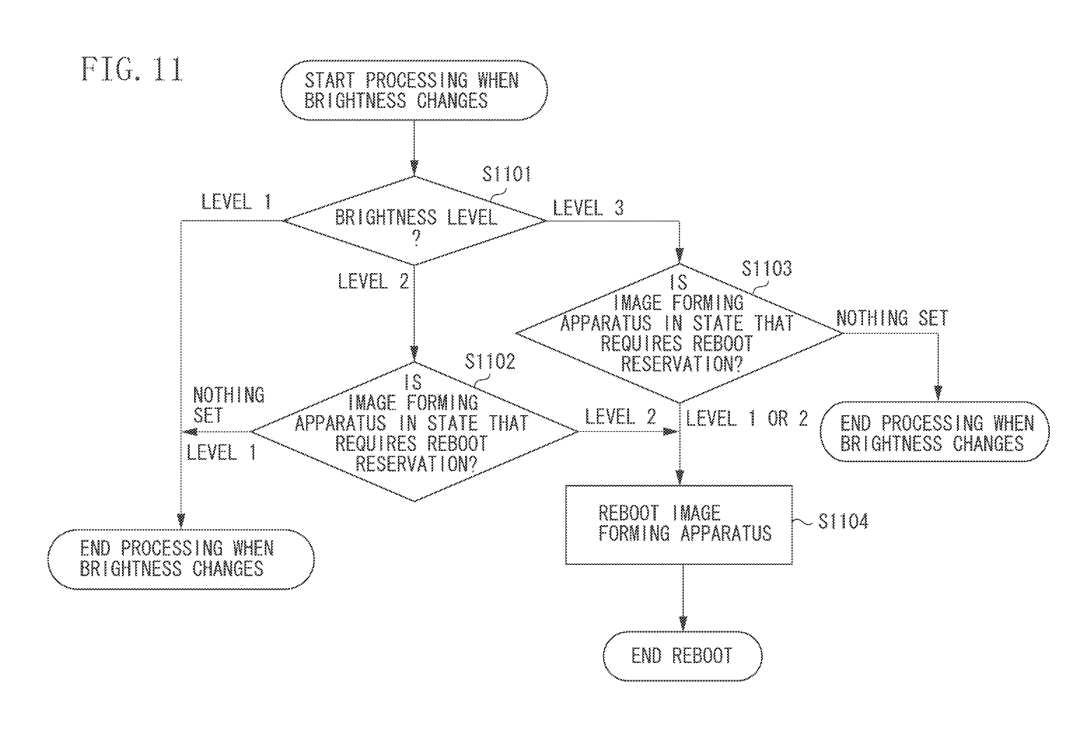

FIG. 11 is a flowchart illustrating a method for controlling the image forming apparatus according to the present exemplary embodiment. The present example is an example of processing performed when the lightness sensor 117 provided to the image forming apparatus 100 detects that the brightness level is dark beyond a threshold value. The CPU 111 executes the control program stored in the ROM 112 or HDD 114, by which the respective steps are realized. In step S1101, the CPU 111 determines the current brightness level from the output level of the lightness sensor 117. At this time, the CPU 111 changes the processing according to the current brightness level around the main body of the image forming apparatus. More specifically, if the CPU 111 determines in step S1101 that the brightness level is the highest level, the level 1 (LEVEL 1 in step S1101), the CPU 111 ends the present processing immediately without referring to the abnormal state held by the not-illustrated holding unit.

On the other hand, if the CPU 111 determines in step S1101 that the brightness level is the level 2 (LEVEL 2 in step S1101), the CPU 111 refers to the abnormal state held by the holding unit, and determines whether nothing is set as the level associated with this abnormality or the level 1 is set thereto, i.e., whether the image forming apparatus is in a state that requires a reboot reservation. If the CPU 111 determines in step S1102 that a reboot reservation is unnecessary (NOTHING SET OR LEVEL 1 in step S1102), the CPU 111 determines that reboot is unnecessary, and then ends the present processing.

If the CPU 111 determines in step S1102 that the level associated with the abnormality is the level 2 (LEVEL 2 in step S1102), the CPU 111 determines that a phenomenon corresponding to the above-described memory leak has occurred, and the processing proceeds to step S1104. In step S1104, the CPU 111 performs the conventional commonly-used reboot processing, and then ends the present processing.

If the CPU 111 determines in step S1101 that the brightness level is the level 3 (LEVEL 3 in step S1101), the CPU 111 further refers to the abnormal state held by the holding unit, and determines whether nothing is set as the level associated with the abnormality. If the CPU 111 refers to the abnormal state and determines that nothing is set as the level associated with the abnormality in step S1103 (NOTHING SET in step S1103), the CPU 111 determines that reboot is unnecessary, and then ends the present processing.

On the other hand, if the CPU 111 determines in step S1103 that the level associated with the abnormality is the level 1 or the level 2 (LEVEL 1 OR 2 in step S1103), the CPU 111 determines that the above-described memory fragmentation has progressed or a phenomenon corresponding to the memory leak has occurred, and the processing proceeds to step S1104. In step S1104, the CPU 111 performs the conventional commonly-used reboot processing, and then ends the present processing.

According to the above-described processing, it is possible to detect in a stepwise manner whether the image forming apparatus could shift to an abnormal state to reserve the reboot processing, and perform the reboot processing according to the stages of the levels associated with the ambient brightness and the abnormality.

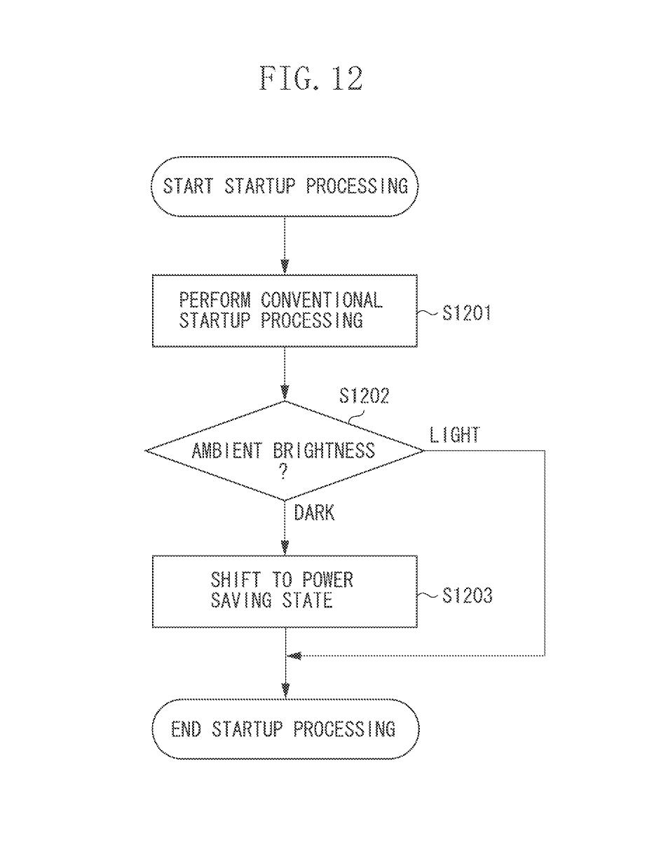

A third exemplary embodiment will be described. The present exemplary embodiment is an embodiment contrived by focusing on the fact that, in the respective above-described exemplary embodiments, the image forming apparatus is rebooted only when it is dark around the image forming apparatus to some extent. FIG. 12 is a flowchart illustrating a part of startup processing performed by the image forming apparatus according to the present exemplary embodiment. The processing illustrated in the flowchart is an example of power control for shifting the system to the power saving mode according to the brightness level around the main body of the image forming apparatus, which is detected by the lightness sensor 117, after the image forming apparatus has been rebooted by a reboot unit. The details thereof will be described now. The CPU 111 executes the control program stored in the ROM 112 or HDD 114, by which the respective steps are realized.

In step S1201, the CPU 111 performs a conventional series of startup processes, i.e., transferring a program code stored in the HDD 114 of the image forming apparatus to the RAM 113. In step S1202, the CPU 111 checks the ambient brightness based on an output of the lightness sensor 117. At this time, the CPU 111 compares the ambient brightness with a preset threshold value. If the CPU 111 determines that sufficient brightness is detected (LIGHT in step S1202), the CPU 111 ends the startup processing with nothing performed.

On the other hand, if the CPU 111 determines in step S1202 that it is dark around the image forming apparatus (DARK in step S1202), the CPU 111 shifts the image forming apparatus to the power saving mode, and then ends the present processing.

According to the above-described processing, in the first and second exemplary embodiments, the ambient brightness is checked after the image forming apparatus has been rebooted. The image forming apparatus can automatically shift to the power saving mode upon detection that it is sufficiently dark around the image forming apparatus, i.e., the user less likely uses the image forming apparatus immediately after the reboot.

Aspects of the present disclosure can also be realized by a computer of a system or apparatus (or devices such as a CPU or MPU) that reads out and executes a program recorded on a memory device (computer-readable storage medium) to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable storage medium). In such a case, the system or apparatus, and the recording medium where the program is stored, are included as being within the scope of the present invention.

While the present disclosure has been described with reference to exemplary embodiments, it is to be understood that these embodiments are not limiting. The scope of the following claims is to be accorded the broadest interpretation so as to encompass all modifications, equivalent structures, and functions.

This application claims priority from Japanese Patent Application No. 2012-187392 filed Aug. 28, 2012, which is hereby incorporated by reference herein in its entirety.

What is claimed is:

1. An image forming apparatus configured to perform image processing while managing a resource of a system, the image forming apparatus comprising:
a detection unit configured to detect a brightness level around a main body of the image forming apparatus; and
a control unit configured to:
reboot the resource of the system;
check a state in which the system should be rebooted to determine which level the state has shifted to;
reserve reboot processing according to the determined level; and
control whether the reboot processing should be performed according to the detected brightness level and a level of the reserved reboot processing.

2. The image forming apparatus according to claim 1, wherein the detection unit detects at least three stages of brightness levels.

3. The image forming apparatus according to claim 1, wherein the resource of the system includes a volatile memory.

4. The image forming apparatus according to claim 3, wherein the volatile memory is managed with memory blocks of a plurality of capacities assigned to a single block.

5. The image forming apparatus according to claim 1, wherein the control unit determines that the level of the reboot processing is a high level in a case where a predetermined available capacity cannot be secured in a volatile memory.

6. The image forming apparatus according to claim 1, wherein the control unit determines that the level of the reboot processing is a middle level in a case where a predetermined continuous available capacity cannot be secured in a volatile memory.

7. The image forming apparatus according to claim 1, further comprising a power control unit configured to shift the system to a power saving mode according to the brightness level around the main body of the image forming apparatus, which is detected by the detection unit, after the control unit has performed the reboot processing.

8. A method for controlling an image forming apparatus configured to perform image processing while managing a resource of a system, the method comprising:
rebooting the resource of the system;
checking a state in which the system should be rebooted to determine which level the state has shifted to;
reserving reboot processing according to the determined level;
detecting a brightness level around a main body of the image forming apparatus; and
controlling whether the reboot processing should be performed according to the detected brightness level and a level of the reserved reboot processing.

9. The method for controlling the image forming apparatus according to claim 8, further comprising shifting the system to a power saving mode according to the detected brightness level around the main body of the image forming apparatus after the reboot processing has been performed.

10. A computer-readable storage medium storing computer-executable instructions for causing a computer to execute the method for controlling the image forming apparatus according to claim 8.
